(19) United States
(12) Patent Application Publication
(10) Pub. No.: US 2009/0091112 A1
(43) Pub. Date: Apr. 9, 2009

(54) BACK SPLASH HOLDER ASSEMBLY

(75) Inventor: Steve Fredrickson, Murray, UT (US)

Correspondence Address: Workman Nydegger;1000 Eagle Gate Tower, 60 East South Temple, Salt Lake City, UT, 84111, US

(73) Assignee: ACCENT SURFACES, LLC, Murray, UT (US)

(21) Appl. No.: 11/866,509

(22) Filed: Oct. 3, 2007

(51) Int. Cl. B60R 13/00; B60R 13/04

(52) U.S. Cl. 280/762; 248/220.21

(57) ABSTRACT

A backsplash holder is configured to receive a backsplash object therein and is configured to be mounted on a vehicle. The backsplash holder includes an elongate member having a receiving surface, a first sidewall extending from the receiving surface, and an opposing second side wall extending from the receiving surface.

### TECHNICAL FIELD

The present disclosure relates to a backsplash holder configured to be mounted to a vehicle and to carry at least one backsplash object.

### BACKGROUND

Custom counter tops are counter tops which are made in order to fit a selected space, such as a kitchen, bathroom, or other area. Counter tops frequently include a main portion that rests generally horizontally on a support structure. Backsplashes are often provided with the counter tops. Backsplashes cover the area behind and above a countertop to assist in preventing water or other material from splashing onto the adjoining vertical surface, such as wallboard.

Solid-surface counter tops are becoming popular for a number of reasons, including aesthetics and durability. In particular, solid-surface counter tops often allow cooks to place hot objects, such as pots, directly on the surface. Backsplashes used with solid-surface counter tops are often provided separately from the counter tops themselves.

Solid-surface counter tops as well as the backsplashes are often fabricated at a location that is remote from where they are eventually installed. Consequently, the counter tops and backsplashes are often transported from a fabrication location to the installation location. It may be desirable to minimize rubbing between the countertop components and/or the backsplashes. Consequently, it may be desirable to carry the backsplashes separately from the countertops. Frequently, attempts to carry the backsplashes separately have included placing the backsplashes in the back of a transport vehicle, such as in the back of a pickup truck. While separating the backsplashes from the countertops, the backsplashes are often allowed to bounce as the vehicle travels. The elongated nature of the backsplashes often causes the backsplashes to break if the backsplashes are not secured and are allowed to bounce with the vehicle.

### SUMMARY

In one of many possible embodiments, a backsplash holder is provided that is configured to receive a backsplash object therein and is configured to be mounted on a vehicle. The backsplash holder includes an elongate member having a receiving surface, a first sidewall extending from the receiving surface, and an opposing second side wall extending from the receiving surface.

In another example, a backsplash holder assembly is provided that is configured to receive a backsplash object therein and configured to be adjustably mounted on a vehicle. The backsplash holder includes a main rack. The main rack includes an elongate member having a receiving surface, a first sidewall extending from the receiving surface, and an opposing second side wall extending from the receiving surface. The main rack also includes a mounting assembly including a plurality of stake assemblies.

### BRIEF DESCRIPTION OF THE DRAWINGS

The accompanying drawings illustrate various embodiments of the present system and method and are a part of the specification. The illustrated embodiments are merely examples of the present system and method and do not limit the scope of the disclosure.

FIG. 1A illustrates a perspective view of a backsplash holder assembly secured to a vehicle according to one example;

FIG. 1B illustrates an exploded perspective view of a backsplash holder assembly in relationship to a vehicle according to one example;

FIG. 1C illustrates an exploded perspective view of a backsplash holder and backsplash according to one example;

FIG. 2A illustrates a perspective view of a main rack of a backsplash holder assembly according to one example;

FIG. 2B illustrates another perspective view of the main rack illustrated in FIG. 2A according to one example;

FIG. 3A illustrates a perspective view of a stake assembly according to one example;

FIG. 3B illustrates a perspective view of a stake assembly according to one example; and

FIG. 4 illustrates an elevated view of a backsplash holder assembly according to one example.

### DETAILED DESCRIPTION

Systems and methods are provided herein for securing elongate counter-top elements, such as backsplashes made from solid surfaces including composite solid surface materials as well as natural surfaces materials like granite, for transport by a vehicle. In one example, a rack assembly is provided that includes a main rack and a mounting assembly. The mounting assembly may include features that engage rail pockets or other features standard to vehicles.

In one example, the mounting assembly includes adjustable stake assemblies to couple the rack assembly and the mounting assembly in particular to a vehicle. The adjustable nature of the mounting assembly allows the backsplash holder assembly to be conveniently and rapidly mounted to vehicles with differing rail pocket configurations. In addition, the backsplash assembly may include a main rack with strapping openings and strapping tabs to allow backsplashes to be rapidly secured to the main rack for transport. Throughout the drawings, identical reference numbers designate similar, but not necessarily identical, elements.

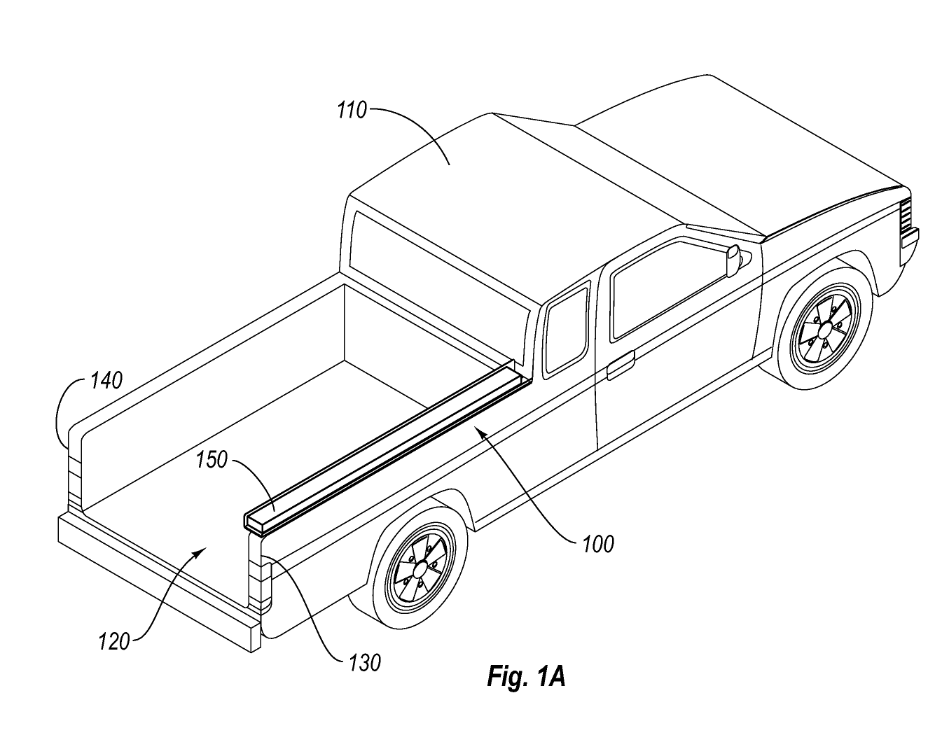

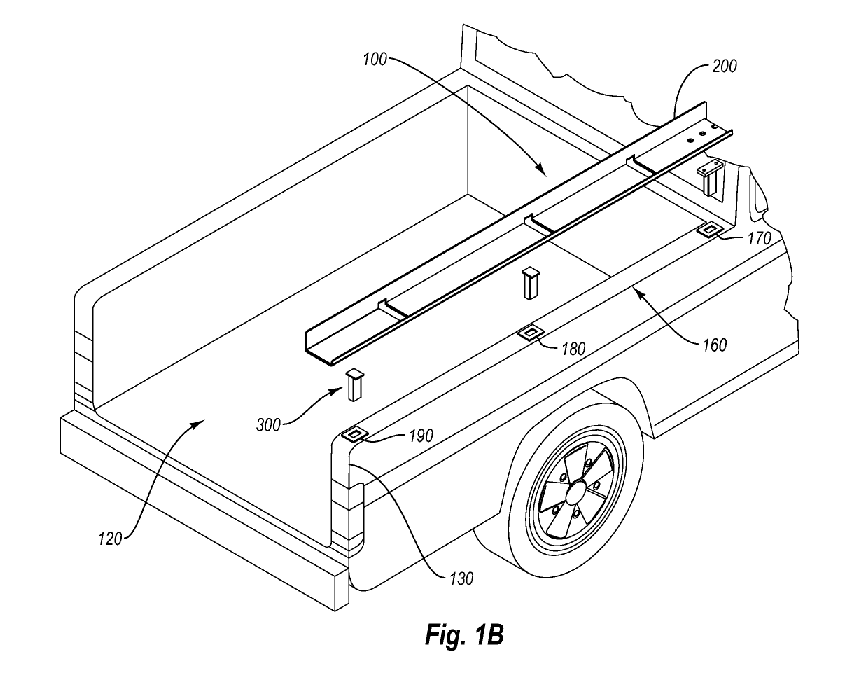

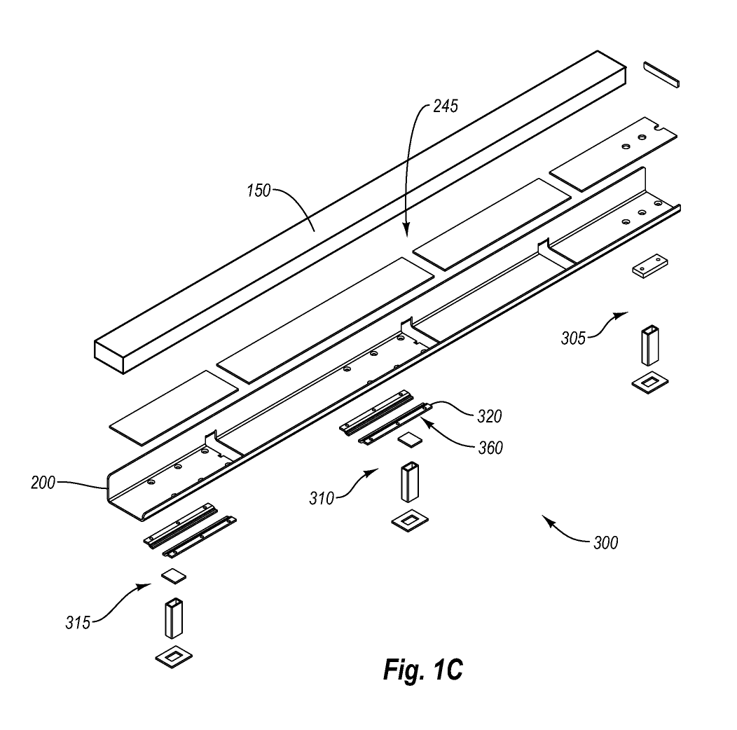

FIG. 1A is a backsplash holder assembly 100 coupled to a vehicle 110. The vehicle 110 illustrated is a pick-up truck with a bed 120. The bed 120 has sides 130, As illustrated in FIG. 1A, the backsplash holder assembly 100 is mounted to the first side 130. The backsplash holder assembly 100 is configured to receive an elongate portion of countertop or other material, such as a backsplash 150.

In particular, FIG. 1B is an exploded view which shows the backsplash holder assembly 100 above the side 130 to which it is mounted in FIG. 1A. As illustrated in FIG. 1B, the side 130 includes a bed rail 160. The bed rail 160 includes a plurality of rail pockets 170, 180, 190 formed therein. While three rails pockets 170, 180, 190 are illustrated, other configurations are possible. Further, the spacing between the rail pockets 170, 180, 190 may also vary.

The backsplash holder assembly 100 includes several components, including a main rack 200 and a mounting assembly 300. The main rack 200 is configured to receive the backsplash 150. The mounting assembly 300 is to be coupled to the main rack 200 and is configured to mount the main rack 200 to the vehicle 110. In particular, FIG. 1C is one example of the mounting assembly 300 that includes a plurality of stake assemblies 305, 310, 315. The stake assemblies 305, 310, 315 are configured to engage the rail pockets 170, 180, 190 to thereby providing a plurality of mounting points to secure the backsplash holder assembly 100 to the vehicle 110.

The mounting assembly 300 is configured to allow one or more of the stake assemblies 305, 310, 315 to translate to engage corresponding rail pockets 170, 180, 190 to thereby allow the backsplash holder assembly 100 to be mounted to a variety of vehicles. The main rack 200 will be discussed in detail first, followed by a detailed discussion of the mounting assembly 300. Later, engagement between the main rack 200 and the mounting assembly 300 will be discussed in more detail.

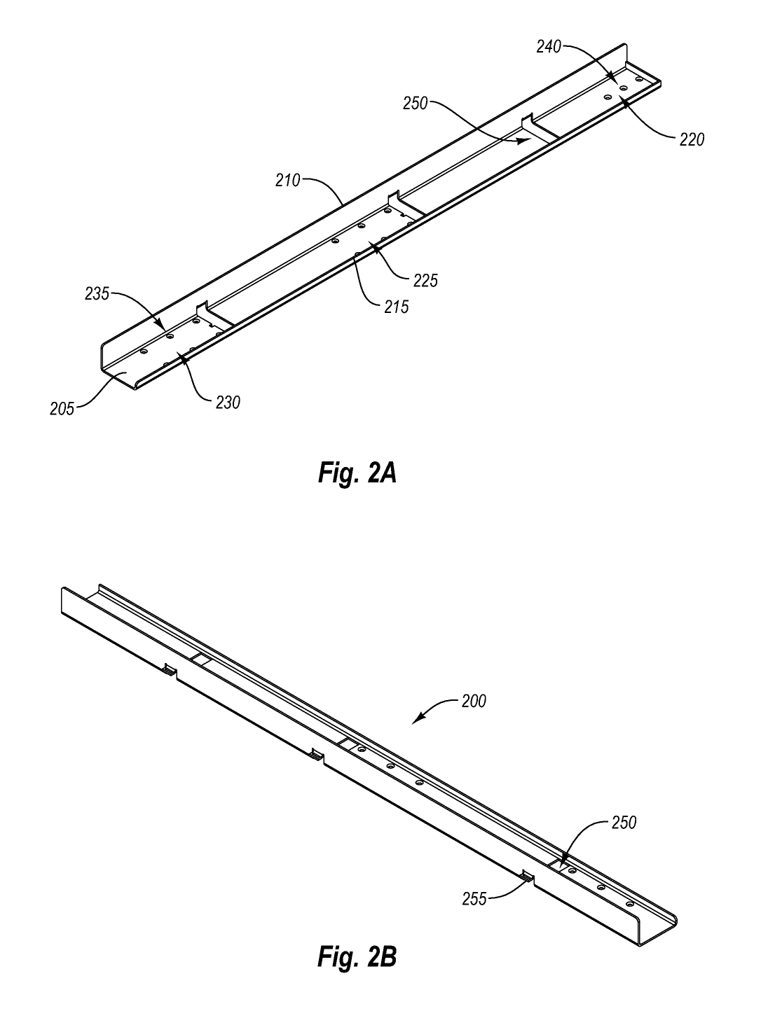

FIG. 2A is a perspective view of the main rack 200 according to one example. The main rack 200 includes an elongate member having a receiving surface, such as base member 205. A first side wall 210 extends away from the base member 205. A second side wall 215 also extends away from the base member 205. In the illustrated example, the first side wall 210 and the second side wall 215 are opposing.

Further, the first side wall 210 extends further from the base member 205 than the second side wall 215. The first side wall 210 and second side wall 215 may be approximately parallel to each other. Additionally, the first side wall 210 and/or the second side wall 215 may approximately perpendicular to the base member 205.

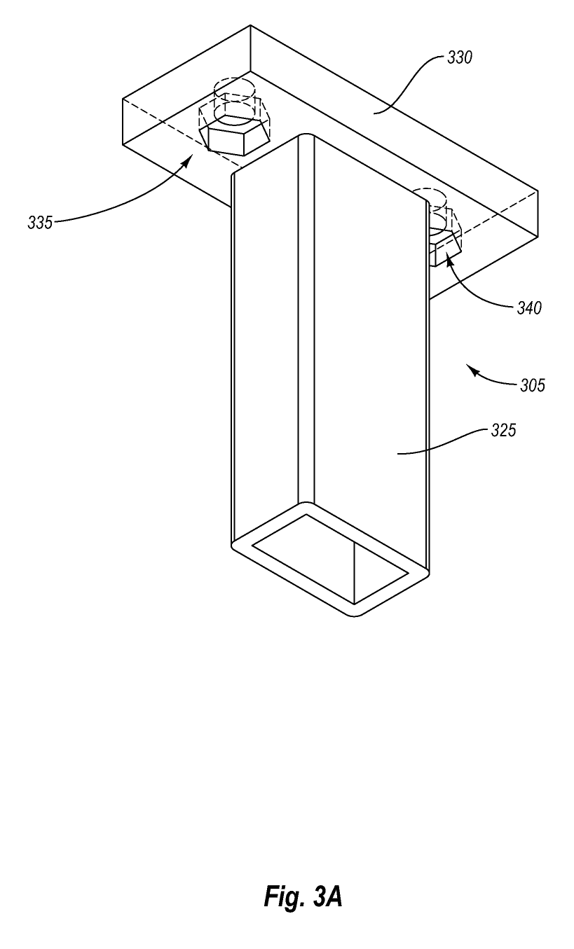

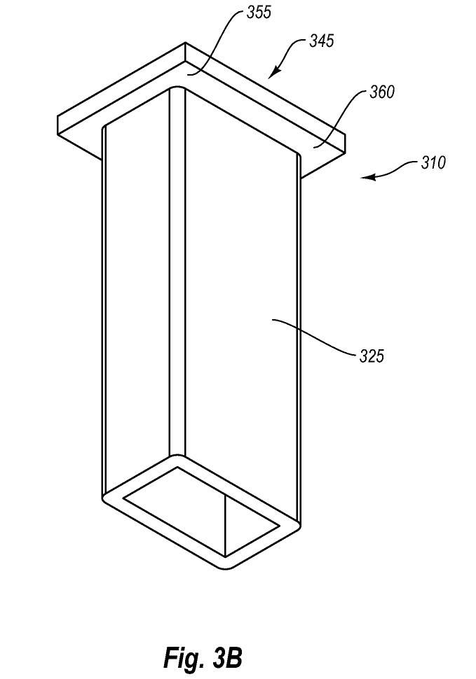

The base member 205 has a drilling configuration defined therein to allow the main rack 200 to engage the mounting assembly 300 (discussed in more detail with reference to FIG. 3). In particular, the drilling configuration includes first, second, and third hole patterns 220, 225, 230 respectively. The first hole pattern 220 may generally include a three holes separated by a space and may be near a first end 235 of the base member 205.

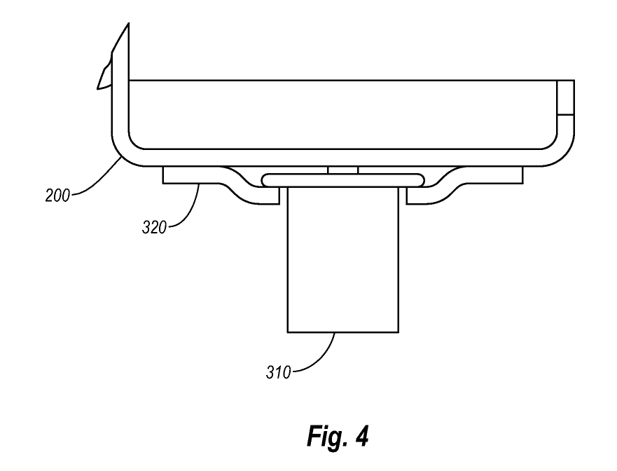

The third hole pattern 230 may be located near a second end 240 and may include three holes near one edge of the base member 205 and three holes on an opposing edge of the base member 205 at approximately the same relative distance from the second end 240. The second hole pattern 225 may be substantially similar to the third hole pattern 230 and may be located between the first hole pattern 220 and the third hold pattern 230. As will be discussed in more detail with reference to FIG. 4, the configuration of the hole patterns 220, 225, 230 may allow the rack to be set up to be rapidly installed on a variety of vehicles.

Turning again to FIG. 1C, backsplash holder assembly 100 may also include a plurality of rubber pads 245. The rubber pads 245 may be secured to the main rack 200 in any suitable manner, such as by friction, by adhesives, by fasteners, or in any suitable manner. The rubber pads 245 may provide a high friction surface that is also cushioned to support a backsplash 150 (FIG. 1) or other elongate element. The high friction and cushioned support provided by the rubber pads 245 may allow the main rack 200 to securely support a backsplash 150 (FIG. 1) while minimizing slippage and damage to the backsplash 150.

As illustrated in FIG. 2B, the main rack 200 also includes at least one strapping opening 250. The main rack 200 may include any number of strapping openings 250. Each strapping opening 250 may be formed in a portion of both the first side wall 210 and the base member 205. In one example, the strapping opening 250 extends across a substantial portion of the base member 205. The main rack 200 may also include a strapping tab 255 near the end of the strapping opening 250 in the first side wall 210. The strapping tab 255 illustrated extends generally away from the first side wall 210, opposite the base member 205.

The strapping tab 255 provides an anchoring point to allow a strapping member, such as an elastic strap, to be anchored thereto. In one example, a standing end of an elastic strap may be anchored to the strapping tab 255, such as after the backsplash 150 (FIG. 1A) has been placed on the main rack 200 and onto the rubber mats 245. After the standing end of the elastic strap has been anchored to the strapping tab 255, the tag end may be routed over the top of backsplash 150 and through the strapping opening 250 near the second side wall 215.

The strapping element may then be routed under the backsplash 150, which extends over the strapping opening 250. The strapping element may then be routed back through the strapping opening 250 and back to the strapping tab 255, where the strapping element may again be secured.

Returning again to FIG. 1C, various components of the mounting assembly 300 are shown in more detail, which includes the first, second, and third stake assemblies 305, 310, 315. In the illustrated example, the first stake assembly 305 is a front stake assembly that may be generally stationary while the second and third stake assemblies may be configured to slide relative to the main rack 200. Each of the stake assemblies 305, 310, 315 is configured to be secured to the main rack 200. In particular, the first stake assembly 305 may be secured to the main rack 200. The second and third stake assemblies 310, 315 may be coupled to the main rack 200 by slide rails 320.

FIG. 3A illustrates the first stake assembly 305 and FIG. 3B illustrates the second stake assembly 310 in more detail. In at least one example, the second stake assembly 310 and the third stake assembly 315 (FIG. 1) may be substantially similar. Accordingly, for ease of reference, the second stake assembly 310 alone will be described. The description of the second stake assembly 310 may also apply to the third stake assembly 315.

Both the first and the second stake assemblies 305, 310 include a stake 325. Each stake 325 may be configured to fit within a corresponding rail pocket 170-190 in the bedrail 160 of a vehicle 110 (all illustrated in FIG. 1). With particular reference to FIG. 3A, the first stake assembly 305 further includes a stake mount 330. The stake mount 330 may be secured to the stake 325 in any suitable manner. One suitable manner of securing the stake mount 330 to the front stake 325 may include welding.

The stake mount 330 may be configured to be directly secured to the main rack 200. In particular, as illustrated in FIG. 3A, a stake mounting hole pattern 335 may be defined on a bottom side 340 of the stake mount. The stake mounting hole pattern 335 may include differentially bored holes. In the example illustrated in FIG. 3A, the differentially bored holes may allow for a nut to be placed and retained within one portion of the hole while allowing a bolt or other fastener to pass through the stake mount 330 and into engagement with the nut.

As illustrated in FIG. 3B, the first stake assembly 305 may be secured to the main rack 200 by aligning the two holes of the stake mounting hole pattern 335 to two of the holes in the first hole pattern 220. With the hole patterns thus aligned, a fastener may then be used to used to secure the first stake assembly 305 to the main rain 200 (FIG. 2), such as by passing bolts through the corresponding holes in the first hole pattern 220 to bolts in the differentially sized hole pattern 340 (FIG. 3A). The fasteners may then be tightened to secure the first stake assembly 305 to the main rack 200. The second mounting assembly 310 may also be secured to the main rack 200.

Turning now to FIG. 3B, the second mounting assembly 310 includes the stake 325 as well as a slide 345. The slide 345 may be secured to the stake 325 in any suitable manner, such as by welding. The slide 345 may include edges that extend beyond the lateral sides of the stake 325 when the second stake assembly 310 is assembled to form tabs 350, 355. The tabs 350, 355 are configured to engage corresponding features of the slide rails 320 to allow the second stake assembly 310 to slide relative to the main rack 200 and to be secured at a desired location.

As illustrated in FIG. 1C, each of the slide rails 320 according to the present example include a slide rail hole pattern 360. The slide rail hole pattern 360 defined in each of the slide rails 320 allows two slide rails 320 to be secured to main rack 200 by way of the second hole pattern 225. In particular, the slide rails 320 may be aligned relative to the main rack 200 by aligning the slide rail hole patterns 360 to the second hole pattern 225.

In one example, fasteners, such as bolts may be inserted through the second hole pattern 225, and through the second hole patterns. The holes of one or more of the slide rail hole patterns may be threaded or have a threaded insert located therein to receive a bolt or other fastener to thereby couple the slide rails 320 to the main rack 200.

FIG. 4 illustrates the slide rails 320 secured to the main rack 200. The tabs 350, 355 on the second slide assembly 310 engage the slide rails 320. In particular, the fasteners used to secure the slide rails 320 to the main rack 200 may be tightened to an initial tightness to secure the slide rails 320 while allowing the second stake assembly 310 to slide relative to the main rack 200.

Once the second stake assembly 310 is at the desired position, the fastener may be further tightened to thereby secure the second stake assembly 310 at the desired location relative to the slide rails 320 and the main rack 200. Accordingly, the present configuration allows the second stake assembly 310 as well as the third stake assembly 315 to be moved to a desired location along a continuous range of positions and to be secured at the desired location.

Accordingly, systems and methods have been discussed herein for securing elongate counter-top elements, such as backsplashes made from solid surfaces including composite solid surface materials as well as natural surfaces materials like granite, for transport by a vehicle. In one example, a rack assembly is provided that includes a main rack and a mounting assembly. The mounting assembly may include features that engage rail pockets or other features standard to vehicles.

In one example, the mounting assembly includes adjustable stake assemblies to couple the rack assembly to the mounting assembly in particular to a vehicle. The adjustable nature of the mounting assembly allows the backsplash holder assembly to be conveniently and rapidly mounted to vehicles with differing rail pocket configurations.

The preceding description has been presented only to illustrate and describe exemplary embodiments. It is not intended to be exhaustive or to limit the disclosure to any precise form disclosed. Many modifications and variations are possible in light of the above teaching. It is intended that the scope of the disclosure be defined by the following claims.

What is claimed is:

1. A backsplash holder configured to receive a backsplash object therein and configured to be mounted on a vehicle, the backsplash holder comprising:
an elongate member having a receiving surface;
a first sidewall extending from the receiving surface; and
an opposing second side wall extending from the receiving surface.

2. The backsplash holder of claim 1, further comprising at least one strapping opening defined in at least a portion of the receiving surface and the first sidewall.

3. The backsplash holder of claim 2, further comprising at least one strapping tab coupled to the first sidewall.

4. The backsplash holder of claim 1, further comprising a plurality of hole patterns defined therein.

5. The backsplash holder of claim 4, wherein the hole patterns include a first hole pattern for securing a first stake assembly to the backsplash holder and a second hole pattern for securing a second stake assembly to the backsplash holder.

6. The backsplash holder of claim 1, further comprising at least one rubber mat, the rubber mat being sized to rest on at least a portion of the receiving surface.

7. A backsplash holder assembly configured to receive a backsplash object therein and configured to be adjustably mounted on a vehicle, the backsplash holder comprising:
a main rack, the main rack including an elongate member having a receiving surface, a first sidewall extending from the receiving surface, and an opposing second side wall extending from the receiving surface; and
a mounting assembly including a plurality of stake assemblies.

8. The assembly of claim 7, wherein the mounting assembly includes a plurality of slide rails secured to the main rack.

9. The assembly of claim 8, wherein the stake assemblies include a first stake assembly configured to engage a front rail pocket on a vehicle and a second stake assembly configured to engage a rail pocket separate from the front rail pocket.

10. The assembly of claim 9, wherein the first stake assembly includes a stake and a stake mount secured to the stake.

11. The assembly of claim 10, wherein the stake mount includes a differentially-sized hole pattern.

12. The assembly of claim 10, wherein the stake mount includes a nut coupled thereto.

13. The assembly of claim 10, wherein the second assembly includes a slide and a stake secured to the slide.

14. The assembly of claim 12, wherein the slide configured to slide rail is configured to engage the slide to allow the stake assembly to be adjustably positioned relative to the main rack.

15. A backsplash holder assembly configured to receive a backsplash object therein and configured to be adjustably mounted on a vehicle, the backsplash holder comprising:
a main rack, the main rack including an elongate member having a receiving surface, a first sidewall extending from the receiving surface, and an opposing second side wall extending from the receiving surface;
a first hole pattern and a second hole pattern defined in the main rack; and
a mounting assembly including front stake assembly, a second stake assembly, and at least one slide rail, the front stake assembly including a stake and a stake mount, the second stake assembly including a stake and a slide, wherein the front stake assembly is configured to be secured to the main rack using the first hole pattern and the second stake assembly is configured to be secured to the main rack using the second hole pattern.

16. The assembly of claim 1, wherein the slide is configured to be positioned at least partially between the slide rail and the main rack.
